(19) United States
(12) Patent Application Publication
(10) Pub. No.: US 2025/0214043 A1
(43) Pub. Date: Jul. 3, 2025

(54) Swirl-type Liquid Raw Material In-line Static Mixer

(71) Applicant: The University of Nottingham Ningbo China, Ningbo (CN)

(72) Inventors: Nicholas James Miles, Ningbo (CN); Philip Hall, Ningbo (CN); Guozhen Li, Ningbo (CN); Zheng Wang, Ningbo (CN)

(21) Appl. No.: 18/397,603

(22) Filed: Dec. 27, 2023

(51) Int. Cl. B01F 23/451; B01F 25/00; B01F 25/10

(52) U.S. Cl. CPC B01F 23/451; B01F 25/102; B01F 2025/913

(57) ABSTRACT

Disclosed is a swirl-type liquid raw material in-line static mixer. In an apparatus, a pipe body extends along its central axis; a first raw material inlet is arranged at a top end of the pipe body and is collinear with the central axis; a second raw material inlet is arranged on a side wall of the pipe body and is perpendicular to the central axis; a first swirl pipe is arranged in the pipe body and connects with the first raw material inlet; a second swirl pipe is arranged in the pipe body and connects with the first swirl pipe and the second raw material inlet; a third swirl pipe is arranged in the pipe body and connects with the second swirl pipe; an outlet is arranged at a bottom end of the pipe body and connects with the third swirl pipe.

### TECHNICAL FIELD

The present disclosure relates to the field of liquid raw material mixing, in particular to a swirl-type liquid raw material in-line static mixer.

### BACKGROUND

Mixing operation is a pretreatment process in industrial production, raw material mixing in food processing, and many other processes, the quality of mixing directly affects the production efficiency and product quality. In liquid-liquid mixing applications, the mixing apparatus may be divided into dynamic mixer and static mixer according to whether there is a movable element. The static mixer does not require additional driving device, but rely on the kinetic energy of the fluid impacting the internal static elements to increase the velocity gradient and turbulent kinetic energy of the fluid, and to cut and mix the raw material. The dynamic mixer relies on its movable element to generate strong shear stretching capability and good mixing performance. Despite the differences between the presence or absence of movable elements, the mixing principle of the static mixer and the dynamic mixer is to achieve good dispersion and sufficient mixing between fluids through the generation of fluid splitting and a swirl flow phenomenon. In the field of petrochemical engineering and food processing, mixers mostly work under a closed processing condition, where it is not convenient to include external driving devices, and the static mixer without the movable element has certain advantages. The static mixers belong to a pipe-type apparatus, which typically do not occupy a large space, are relatively simple in internal structure, and typically require low energy consumption and maintenance. At present, the internal swirl generating units of common SK-type and SV-type static mixers are spiral sheets with alternative left and right twists welded inside the pipe, whose structures are relatively complex, generating great pressure loss as the spiral sheets are welded internally, giving rise to difficulties to the cleaning and maintenance of the devices, and causing risks of blocking the pipeline. Aiming to address this technical problem, the present patent proposes an in-line pipe mixer with lower energy consumption, having a self-cleaning function, and being easy to maintain.

The above information disclosed in the background art is only used to enhance the understanding of the background of the present disclosure, and may therefore contain information that does not constitute the prior art known to a person of ordinary skill in the art.

### SUMMARY

In order to solve the above problem, the present disclosure provides a swirl-type liquid raw material in-line static mixer, aiming to achieve an intensive in-line mixing action of two or more raw materials under the condition of continuous material feeding in the processes of conveying, processing, and filling etc., It ensures the uniformity of the raw materials being fed and the quality of products, with lower energy consumption and reduced device maintenance costs. The objectives of the present disclosure are implemented through the following technical solutions.

A swirl-type liquid raw material in-line static mixer which includes:
a pipe body, extending along its central axis;
a first raw material inlet, arranged at a top end of the pipe body and collinear with the central axis;
a second raw material inlet, arranged on a side wall of the pipe body and perpendicular to the central axis;
a first swirl pipe, arranged in the pipe body and connecting with the first raw material inlet;
a second swirl pipe, arranged in the pipe body and connecting with the first swirl pipe and the second raw material inlet;
a third swirl pipe, arranged in the pipe body and connecting with the second swirl pipe; and
an outlet, arranged at a bottom end of the pipe body and connecting with the third swirl pipe, where the first swirl pipe, the second swirl pipe, and the third swirl pipe each include an inner pipe wall located in the pipe body, and each inner pipe wall includes:
a first transition section, located at the upper end of the inner pipe wall and having a first length and a first cross section in a longitudinal direction of a swirl pipe, wherein the first cross section gradually changes smoothly from a circle with a radius of R to a lobed shape while being twisted by a first predetermined angle longitudinally along with the first transition section. The said lobed shape includes a square with a side length of 2r and a semicircle having a radius of r and extending on each side of the square, with the cross-sectional area of the said first cross section remains unchanged;
a swirl section, connected to the first transition section and having a second length and a second cross section in the longitudinal direction of the swirl pipe, wherein the second cross section is twisted by a second predetermined angle longitudinally along with the swirl section, and the second cross section is in a lobed shape; and
a second transition section, connected to the swirl section, located at the lower end of the inner pipe wall and having a third length and a third cross section in the longitudinal direction of the swirl pipe, wherein the third cross section gradually changes smoothly from a lobed shape to a circle with a radius of R while being twisted by a third predetermined angle longitudinally along with the second transition section, and a cross-sectional area of the third cross section remains unchanged, and the first cross section, the second cross section and the third cross section are the same in cross-sectional area.

In the swirl-type liquid raw material in-line static mixer, the second raw material inlet includes two inlet pipes arranged on opposite sides of the pipe body and being not on the same horizontal plane.

In the swirl-type liquid raw material in-line static mixer, the rotation direction of the first swirl pipe is opposite to that of the second swirl pipe, and a rotation direction of the third swirl pipe is opposite to that of the second swirl pipe.

In the swirl-type liquid raw material in-line static mixer, a pipe body between the first swirl pipe and the second swirl pipe is a premix region, with a length being 1 to 120 times the diameter of the first swirl pipe.

In the swirl-type liquid raw material in-line static mixer, a pipe body between the third swirl pipe and the second swirl pipe is a straight pipe, with a length being 1 to 120 times diameter of the second swirl pipe.

In the swirl-type liquid raw material in-line static mixer, at least one swirl pipe with opposite rotation directions is sequentially arranged between the outlet and the third swirl pipe.

In the swirl-type liquid raw material in-line static mixer, the lobed shape is a 2-lobed shape, a 3-lobed shape, a 4-lobed shape, a 5-lobed shape or a 6-lobed shape.

In the swirl-type liquid raw material in-line static mixer, the first predetermined angle is 90 degrees, the second predetermined angle is 180 degrees, and the third predetermined angle is 80 degrees.

In the swirl-type liquid raw material in-line static mixer, a twisting angle of the first cross section gradually changes based on an a transition curve, where

$$α = {[ \frac{1 - cos [ {π ( \frac{x}{L} )}^{t} ]}{2} ]}^{k} ,$$

L is the first length, x is a position coordinate of the first cross section in a length direction, t and k are two power-law variation coefficients for the α transition curve to adjust the shape of the transition curve. Preferably, when 0.8<<<1.2, and 0.4<<<0.8, the swirl generating efficiency is optimal.

In the swirl-type liquid raw material in-line static mixer, a twisting angle of the first cross section and/or a twisting angle of the third cross section gradually change/changes based on a Vitoshinsky curve or a cosine function.

Compared with the prior art, the present disclosure has the following beneficial effects:

The present disclosure has no embedded fins, spiral sheets and other resistance pieces; therefore, its pressure drop and energy consumption are quite low, achieving high mass transfer efficiency with minimum energy consumption. The present disclosure also has a self-cleaning function which reduces the maintenance costs, allows a continuous process, and prevents the mixing process being interrupted. The required mixing distance and mounting space are small, since the mixer itself can be regarded as a part of the pipeline, avoiding the disadvantages associated with traditional agitators. It has no moving part, thus minimizing the maintenance costs due to wear of the moving parts. The present disclosure avoids blockage, is easy in installation, and can be made with various shape, size, and materials. The entire process material passively mixed in-line, greatly reducing the volume of agitating tanks, or even avoiding the use of agitating tanks.

The above explanation is only the overview of the technical solutions of the present disclosure, in order to make technical means of the present disclosure more clear and obvious to reach such a degree as capable of being implemented by the person of skill in the art according to contents of the specification, and in order to make the above description, other objectives, features and advantages of the present disclosure more obvious and easier to understand. The specific implementation examples of the embodiments of the present disclosure are illustrated in the below.

### BRIEF DESCRIPTION OF FIGURES

By reading the detailed description of the preferred specific implementations below, the other advantages and benefits of the present disclosure become clearer and more obvious for a person of ordinary skill in the art. Accompanying drawings of the specification are only used to illustrate the preferred implementations and shall not be considered as limiting the present disclosure. Apparently, the accompanying drawings described below are only some embodiments of the present disclosure, and a person of ordinary skill in the art may further acquire other accompanying drawings according to these accompanying drawings without creative labor. Moreover, in the entire accompanying drawings, the same reference numerals represent the same parts.

In the figures:

FIG. 1 is a schematic structural diagram of a swirl-type liquid raw material in-line static mixer of the present disclosure.

FIG. 2 is a schematic diagram of arrangement of a second raw material inlet of a swirl-type liquid raw material in-line static mixer of the present disclosure.

FIG. 3 is a schematic diagram of a swirl formed by two strands of fluid of a second raw material inlet of a swirl-type liquid raw material in-line static mixer of the present disclosure.

FIG. 4 is a distribution diagram of the raw material volume fraction and a liquid raw material flow line trajectory chart of an embodiment of a swirl-type liquid raw material in-line static mixer of the present disclosure.

FIG. 5 is a schematic diagram of the raw material coefficient of variation of an embodiment of a swirl-type liquid raw material in-line static mixer of the present disclosure.

FIG. 6 is a schematic structural diagram of three lobed cross section of an embodiment of a swirl-type liquid raw material in-line static mixer of the present disclosure.

FIG. 7 is a schematic structural diagram of four lobed cross section of an embodiment of a swirl-type liquid raw material in-line static mixer of the present disclosure.

FIG. 8 is a schematic structural diagram of five lobed cross section of an embodiment of a swirl-type liquid raw material in-line static mixer of the present disclosure.

FIG. 9 is a schematic structural diagram of a swirl pipe of an embodiment of a swirl-type liquid raw material in-line static mixer of the present disclosure.

FIG. 10 is a schematic diagram of an inner wall cross section of a certain transition stage position in a transition region of an embodiment of a swirl-type liquid raw material in-line static mixer of the present disclosure.

FIG. 11 is a schematic diagram of different transition modes of an embodiment of a swirl-type liquid raw material in-line static mixer of the present disclosure.

FIG. 12 is a schematic diagram of arrangement of a second raw material inlet of an embodiment of a swirl-type liquid raw material in-line static mixer of the present disclosure.

FIG. 13 is a distribution diagram of the raw material volume fraction of an embodiment of a swirl-type liquid raw material in-line static mixer of the present disclosure.

FIG. 14 is a schematic diagram of the raw material coefficient of variation of an embodiment of a swirl-type liquid raw material in-line static mixer of the present disclosure.

FIG. 15 is a schematic diagram of the arrangement of a second raw material inlet of an embodiment of a swirl-type liquid raw material in-line static mixer of the present disclosure.

FIG. 16 is a schematic diagram of arrangement of a second raw material inlet of an embodiment of a swirl-type liquid raw material in-line static mixer of the present disclosure.

FIG. 17 is a distribution diagram of the raw material volume fraction and a liquid raw material flow line trajectory chart of an embodiment of a swirl-type liquid raw material in-line static mixer of the present disclosure.

FIG. 18 is a schematic diagram of the raw material coefficient of variation of an embodiment of a swirl-type liquid raw material in-line static mixer of the present disclosure.

FIG. 19 is a schematic diagram of the raw material coefficient of variation of an embodiment of a swirl-type liquid raw material in-line static mixer of the present disclosure.

FIG. 20 is a distribution diagram of the raw material volume fraction and a liquid raw material flow line trajectory chart of an embodiment of a swirl-type liquid raw material in-line static mixer of the present disclosure.

FIG. 21 is a schematic diagram of the raw material coefficient of variation of an embodiment of a swirl-type liquid raw material in-line static mixer of the present disclosure.

FIG. 22 is a comparison diagram of the raw material coefficient of variation of three implementations of FIG. 19, FIG. 1 and FIG. 16.

FIG. 23 is a schematic diagram of the arrangement of a second raw material inlet of an embodiment with liquid containing particles of a swirl-type liquid raw material in-line static mixer of the present disclosure.

FIG. 24 is a distribution diagram of the raw material volume fraction of an embodiment with liquid containing particles of a swirl-type liquid raw material in-line static mixer of the present disclosure.

FIG. 25 is a schematic diagram of the raw material coefficient of variation of an embodiment with liquid containing particles of a swirl-type liquid raw material in-line static mixer of the present disclosure.

FIG. 26 is a schematic diagram of the arrangement of a second raw material inlet of an embodiment of a swirl-type liquid raw material in-line static mixer of the present disclosure.

The present disclosure is further explained below in conjunction with accompanying drawings and embodiments.

### DETAILED DESCRIPTION

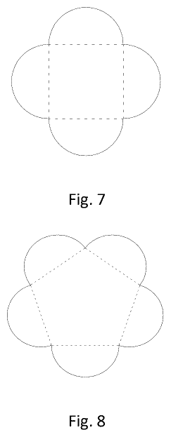

The specific embodiments of the present disclosure will be described in further detail below referring to the accompanying drawings from FIG. 1 to FIG. 26. Though the specific embodiments of the present disclosure are shown in the accompanying drawings, it should be understood that the present disclosure may be implemented by various forms and should not be limited by the embodiments explained herein. On the contrary, these embodiments are provided to understand the present disclosure more thoroughly, and to convey the scope of the present disclosure completely to a person of skill in the art.

It needs to be explained that some terms are used in the specification and claims refer to specific components. A person of skill in the art should be able to understand the terms and technical personnel may use different terms for the same components. The specification and claims do not take a difference of the terms as a form of distinguishing the components, but takes a difference of the functions of the components as a criterion of distinguishing. The phrases, for example, “contain” or “include” mentioned in the specification and claims throughout the article is are open-ended terms, and should be explained as “contain but not limited to”. The following description of the specification is exemplary implementations for implementing the present disclosure, and the description takes general principles of the specification as an objective, and is not used to limit the scope of the present disclosure. The scope of protection of the present disclosure should be subject to the attached claims.

In order to facilitate better understanding of the embodiments of the present disclosure, further explanation will be made below by taking the specific embodiments as examples with reference to the accompanying drawings, and each accompanying drawing does not constitute a limitation to the embodiments of the present disclosure.

In order to better understand, as shown in FIG. 1 to FIG. 26, a swirl-type liquid raw material in-line static mixer includes:
a pipe body 1, extending along its central axis;
a first raw material inlet 2, arranged at a top end of the pipe body 1 and collinear with the central axis;
a second raw material inlet 3, arranged on a side wall of the pipe body 1 and perpendicular to the central axis;
a first swirl pipe 4, arranged in the pipe body 1 and connecting with the first raw material inlet 2;
a second swirl pipe 5, arranged in the pipe body 1 and connecting with the first swirl pipe 4 and the second raw material inlet 3;
a third swirl pipe 6, arranged in the pipe body 1 and connecting with the second swirl pipe 5; and
an outlet, arranged at the bottom end of the pipe body 1 and connecting with the third swirl pipe swirl pipe 6, where the first swirl pipe 4, the second swirl pipe 5 and the third swirl pipe 6 each include an inner pipe wall located in the pipe body 1, and each inner pipe wall includes:
a first transition section 8, located at an upper end of the inner pipe wall, having a first length and a first cross section in a longitudinal direction of a swirl pipe, wherein the first cross section gradually changes smoothly from a circle with a radius of R to a lobed shape while being twisted by a first predetermined angle longitudinally along with the first transition section 8. The said lobed shape includes a square with a side length of 2r and a semicircle having a radius of r and extending on each side of the square, with the cross-sectional area of the said first cross section remains unchanged;
a swirl section 10, connected to the first transition section 8, having a second length and a second cross section in the longitudinal direction of the swirl pipe, wherein the second cross section is twisted by a second predetermined angle longitudinally along with the swirl section 10, and the second cross section is in a lobed shape; and
a second transition section 9, connected to the swirl section 10, located at a lower end of the inner pipe wall and having a third length and a third cross section in the longitudinal direction of the swirl pipe, wherein the third cross section gradually changes smoothly from a lobed shape to a circle with a radius of R while being twisted a third predetermined angle longitudinally along with the second transition section 9, a cross-sectional area of the third cross section remains unchanged, and the first cross section, the second cross section and the third cross section are the same in cross-sectional area.

In a preferred embodiment of the swirl-type liquid raw material in-line static mixer, the second raw material inlet 3 includes two inlet pipes arranged on opposite sides of the pipe body 1 and being not on the same horizontal plane.

In a preferred embodiment of the swirl-type liquid raw material in-line static mixer, the rotation direction of the first swirl pipe 4 is opposite to that of the second swirl pipe 5, and the rotation direction of the third swirl pipe 6 is opposite to that of the second swirl pipe 5.

In a preferred embodiment of the swirl-type liquid raw material in-line static mixer, a pipe body 1 between the first swirl pipe 4 and the second swirl pipe 5 is a premix region 7, with a length being 1 to 120 times diameter of the first swirl pipe 4.

In a preferred embodiment of the swirl-type liquid raw material in-line static mixer, a pipe body 1 between the third swirl pipe 6 and the second swirl pipe 5 is a straight pipe, with a length being 1 to 120 times diameter of the second swirl pipe 5.

In a preferred embodiment of the swirl-type liquid raw material in-line static mixer, at least one swirl pipe with an opposite rotation direction is sequentially arranged between the outlet and the third swirl pipe 6.

In a preferred embodiment of the swirl-type liquid raw material in-line static mixer, the lobed shape is a 2-lobed shape, a 3-lobed shape, a 4-lobed shape, a 5-lobed shape or a 6-lobed shape.

In a preferred embodiment of the swirl-type liquid raw material in-line static mixer, the first predetermined angle is 90 degrees, the second predetermined angle is 180 degrees, and the third predetermined angle is 80 degrees.

In a preferred embodiment of the swirl-type liquid raw material in-line static mixer, a twisting angle of the first cross section gradually changes based on an a transition curve, where

$$α = {[ \frac{1 - cos [ {π ( \frac{x}{L} )}^{t} ]}{2} ]}^{k} ,$$

L is the first length, x is a position coordinate of the first cross section in a length direction, t and k are two power-law variation coefficients for the α transition curve to adjust the shape of the transition curve. Preferably, when 0.8<t<1.2, and 0.4<k<0.8, the swirl generating efficiency is optimal.

In a preferred embodiment of the swirl type liquid raw material in-line static mixer, a twisting angle of the first cross section and/or a twisting angle of the third cross section gradually change/changes based on a Vitoshinsky curve or a cosine function.

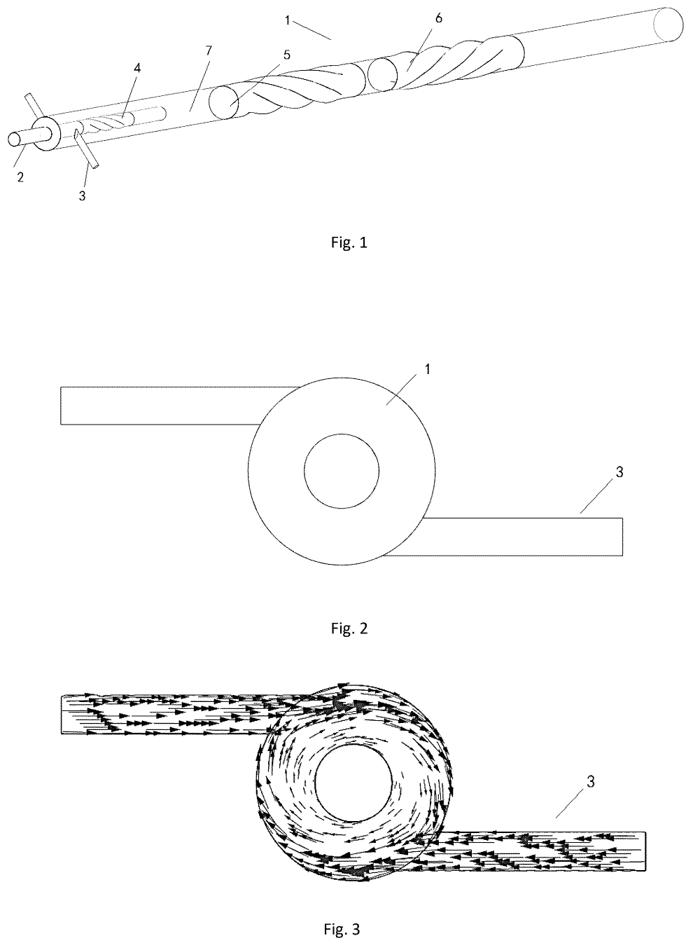

In an embodiment, as shown in FIG. 2, the second raw material inlet 3 is arranged as a tangential inlet mode, that is, one is located at an upper end, and the other is located at a lower end. Two strands of fluid perpendicularly enter an annular region between an inner pipe and an outer pipe to form a swirl, as shown in FIG. 3. The first kind of liquid raw material enters a mixer through the first raw material inlet 2, and passes through the first swirl pipe 4, where a swirl function is applied to the first kind of liquid raw material, enhancing the turbulent flow shear energy and promoting a dispersion effect in a downstream space. A second kind of liquid raw material passes through the second raw material inlet 3, generates a tangential velocity in a tangential inlet mode, and forms a swirl in the annular region between the inner pipe and the outer pipe. The first kind of liquid raw material and the second kind of liquid raw material are swirling flow when entering the premix region 7, having a strong swirl shear effect. The two kinds of fluid generate a sufficient mutual shearing and splitting effects in the premix region 7 and are effectively premixed. The rotation directions of the first and second kind of liquid raw material may be the same or opposite. The rotation direction of one of the two kinds of liquid raw materials is preferred to be opposite to a swirl rotation direction of the second swirl pipe 5, so as to generate further counter-shearing and splitting to enhance mixing. A suitable length of the premix region 7 is 0 to 120 times the diameter d of the first swirl pipe 4, and an optimal length is 40-80 d. The liquid raw materials passing through the premix region 7 have a swirl effect, and a coefficient of variation has decreased to a lower degree. After entering the second swirl pipe 5, the premixed liquid raw materials are superimposed to another swirling effect, further enhancing its mixing uniformity.

A certain straight pipe segment as a mixing effect extension region may be arranged behind the second swirl pipe 5 according to needs, to allow the swirl to continuously develop in the straight pipe segment, further promoting mixing. The mixing function continuing region can reach a length which is 0-120 times the diameter D of the outer pipe, and an optimal length is 40-80 D. The third swirl pipe 6 with the swirl rotation direction opposite to that of the second swirl pipe 5 may be additionally arranged behind a circular pipe segment of a first mixing function continuing region according to needs. A straight pipe segment of a second mixing effect extension region and the fourth swirl pipe whose rotation direction is opposite to that of the third swirl pipe 6 may be arranged behind the second swirl pipe 5 according to needs. Repeat until sufficient mixing of the liquid raw materials is achieved before flowing out from the outlet.

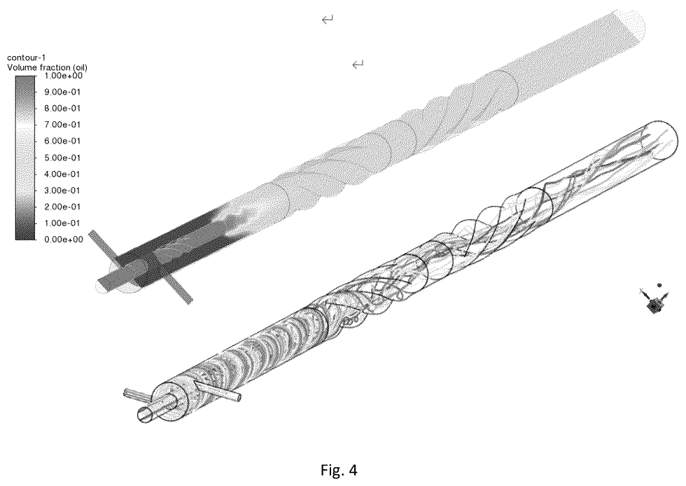

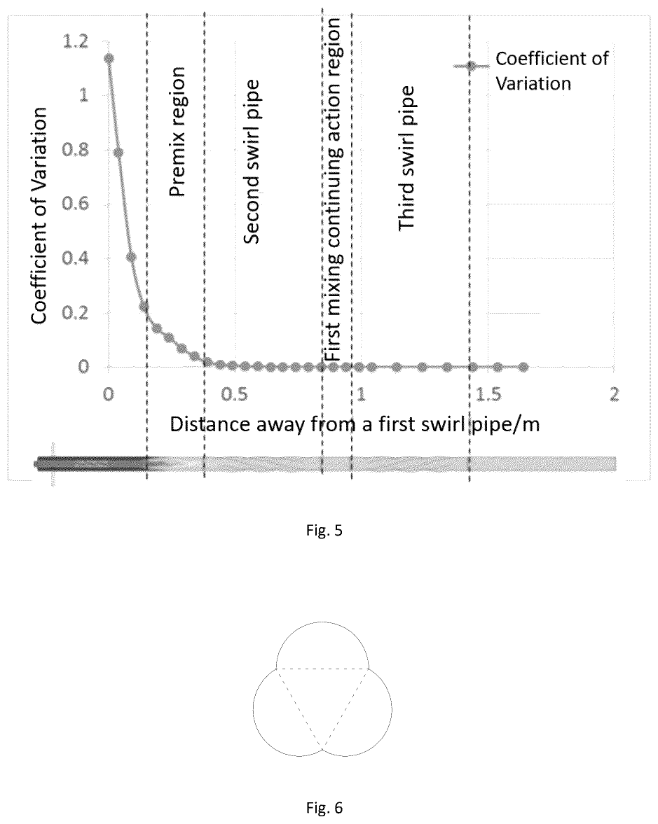

The following is a preliminary CFD simulation of the mixer effect. The first kind of liquid raw material is oil, with the density of 889 kg/m³, the viscosity of 0.00332 kg/(ms), and enters from the first raw material inlet 2 to the mixer. The second kind of liquid raw material is water, with the density of 998.2 kg/m³, and the viscosity of 0.001003 kg/(ms), and enters from the second raw material inlet 3 into the mixer. A surface tension coefficient between oil and water is set as 0.15 N/m. After calculation is completed, the volume fraction distribution of the oil is shown in FIG. 4, where the red represents 100% fraction of the oil, and blue represents 0% fraction of the oil, that is, the fraction of the water is 100%. FIG. 5 shows the coefficient of variation of the two kinds of liquid on a path between an outlet of the first swirl pipe 4 and the outlet with data. To improve the quantify the mixing effect, the coefficient of variation is adopted to evaluate the mixing effect. Generally speaking, a coefficient of variation below 0.05 is good mixing, and a complete mixing is achieved with a value below 0.01.

The coefficient of variation ψ is defined as:

$$ψ = σ / \overline{φ}$$

where σ represents a standard deviation of a mixing concentration distribution on a section, and is obtained through the mixing concentration calculation of all points on the section, expressed as follows:

$$σ = \sqrt{\frac{1}{n} {\sum }_{i = 1}^{n} {( {φ}_{i} - \overline{φ} )}^{2}}$$

φ̅ represents a mean value of the mixing concentration on the section:

$$\overline{φ} = \frac{1}{n} {\sum }_{i = 1}^{n} {φ}_{i}$$

FIG. 5 shows the swirls generated when one liquid raw material and second liquid raw material fluid passes the first swirl pipe 4 and the second raw material inlet 3, which generate a strong dispersion, shear and mixing effect on the two kinds of liquid in the premix region 7, so that the coefficient of variation is reduced from 2.2 to about 0.05 in the premix region 7. Then through remixing of the second swirl pipe 5, the coefficient of variation reached 0.0012, achieving a complete mixing state.

In an embodiment, the first swirl pipe 4, the second swirl pipe 5 or the third swirl pipe 6 in the mixer is composed of a first transition section 8, a swirl section 10 and a second transition section 9. A cross section shape of the swirl section 10 may be a 2-lobed shape, a 3-lobed shape, a 4-lobed shape, a 5-lobed shape, and a 6-lobed shape. The 3-lobed shape, the 4-lobed shape and the 5-lobed shape are the best. As shown in FIG. 6-FIG. 8. When the cross-section shape is the 4-lobed shape, the generated swirl effect is the largest, and the caused pressure loss is the minimum, namely, an energy efficiency ratio is the highest. The swirl section 10 is formed by rotating and stretching the cross section shape anticlockwise or clockwise along the central axis. P D ratio (namely pitch to diameter ratio) of a stretched length to an equivalent radius is suitably controlled between 1 and 16. A rotated angle is suitably between 90 degrees and 720 degrees. The cross section of the first transition section 8 is gradually changed from a circle to the lobed shape cross section and rotates by a certain angle along the longitudinal direction, and its P D ratio is suitably in consistent with the P D ratio of the swirl section 10, and the rotated angle is suitably calculated by the 360°/n, where n is the number of lobes. The cross section of the second transition section 9 is gradually changed from a lobed shape to a circle and rotates by a certain angle along the longitudinal direction, a P D ratio is suitably in consistent with a P D ratio of the swirl section 10, and a rotated angle is suitably calculated by the 360°/n, where n is the number of lobes.

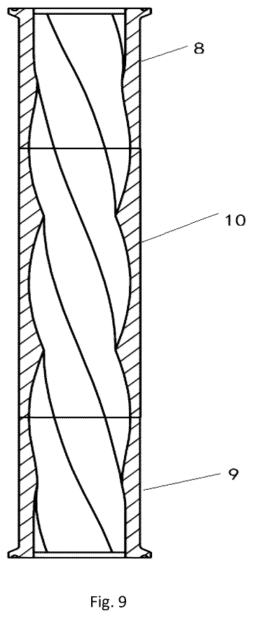

At an earlier stage, a numerical simulation and an experimental verification indicate that the 4-lobed cross section has the optimal energy efficiency, and the 4-lobed shape is taken as an example to introduce a preferred implementation of the swirl pipe, as shown in FIG. 9. The first swirl pipe 4, the second swirl pipe 5 or the third swirl pipe 6 includes an outer pipe wall and an inner pipe wall, wherein
the inner pipe wall includes:
a first transition section 8, located at an upper end of the inner pipe wall and having a first length and a first cross section in a longitudinal direction of a swirl pipe, wherein the first cross section gradually changes smoothly from a circle with a radius of R to a lobed shape while being twisted by a first predetermined angle longitudinally along with the first transition section 8. The said lobed shape includes a square with a side length of 2r and a semicircle having a radius of r and extending on each side of the square, with the cross sectional area of the said first cross section remains unchanged;
a swirl section 10, connected to the first transition section 8 and having a second length and a second cross section in the longitudinal direction of the swirl pipe, wherein the second cross section is twisted by a second predetermined angle longitudinally along with the swirl section 10, and the second cross section is in a lobed shape; and
a second transition section 9, connected to the swirl section 10, located at a lower end of the inner pipe wall and having a third length and a third cross section in the longitudinal direction of the swirl pipe, wherein the third cross section gradually changes smoothly from a lobed shape to a circle with a radius of R while being twisted by a third predetermined angle longitudinally along with the second transition section 9, a cross sectional area of the third cross section remains unchanged, and the first cross section, the second cross section and the third cross section are the same in cross-sectional area.

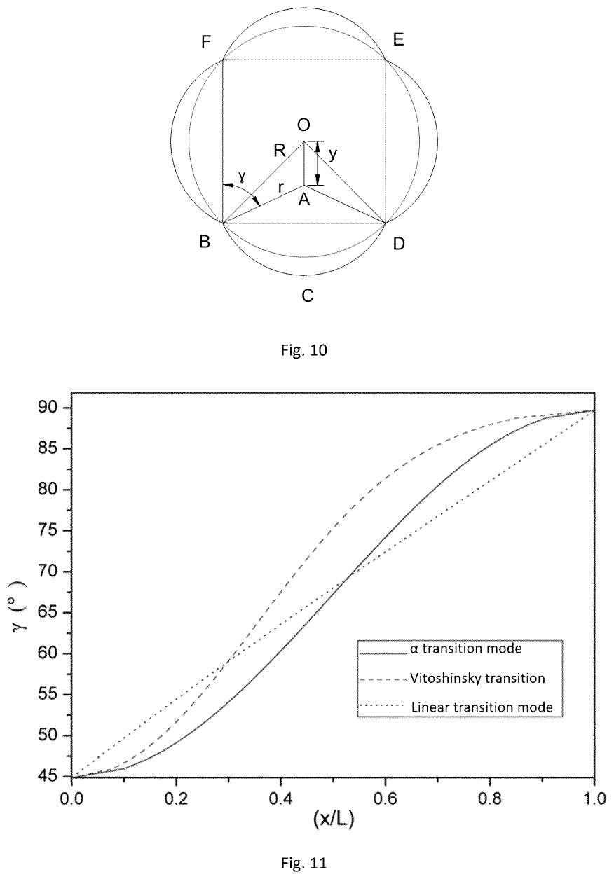

As shown in FIG. 10, in the first transition section and the second transition section 9, the cross-section shape of the pipe inner wall gradually changes from a circle to a lobed shape, while rotating clockwise (+1) or anticlockwise (−1) in an axial direction by a certain preset angle, and the rotated angle is 90 degrees. R is the diameter of the excircle of the internal square when the circular cross section is fully changed into a lobed cross section. r is a radius of a lobe-shaped fan when the circular cross section is fully changed into a lobed cross section. A is a center of a circle of a lobe-shaped fan. y is a distance from A to a square excircle center O. λ is an angle formed between the radius of a lobe-shaped fan and the square vertical edge (FB). When the cross section is a circle, λ is 45 degrees, and when the cross section is a complete lobed shape, λ is 90 degrees. When an angle of λ is gradually increased from 45 degrees to 90 degrees, a series of transition cross sections may be formed. These cross sections are rotated clockwise (or anticlockwise) by a predetermined angle in a process of gradual changing in an axial direction. As shown in FIG. 11, in a process of each cross section rotating clockwise in the axial direction, if spacing changing between cross sections is uniform, the transition mode becomes linear transition. In order to generate a larger swirl intensity and to reduce pressure loss along the way, a smoother transition mode may be designed at a starting section and an ending section of the transition section, that is, the rotated angle within a unit distance is smaller. For example, an a transition curve is based on a cosine function, or a Vitoshinsky curve is used, wherein,

$$α = {[ \frac{1 - cos [ {π ( \frac{x}{L} )}^{t} ]}{2} ]}^{k} .$$

Preferably, in the swirl pipe, the first length is equal to the third length, and the first length and/or the third length are/is half of the second length.

In the swirl pipe, the outer pipe wall is a straight pipe, and the radius R ranges from 0.01 m to 100 m.

In the swirl pipe, a ratio of the first length or the third length to the second length is equal to a ratio of the first predetermined angle or the third predetermined angle to the second predetermined angle.

In the swirl pipe, the first predetermined length is a quarter of the swirl pipe, the second predetermined length is half of the swirl pipe, and the third predetermined length is a quarter of the swirl pipe.

In the swirl pipe, the swirl pipe is connected to a pipeline with a radius R.

In the swirl pipe, the first predetermined angle is 90 degrees, the second predetermined angle is 180 degrees, and the third predetermined angle is 90 degrees.

In the swirl pipe, the sum of the first predetermined angle, the second predetermined angle and the third predetermined angle is 360 degrees.

In the swirl pipe, the ratio of the sum of the first length, the second length and the third length to the radius R is 8:1.

The ratio of the sum of the first length, the second length and the third length to the radius R is 8:1, which is based on the ratio of the swirl intensity generated by the swirl pipe to pressure loss caused by itself. That is, to use the minimum pressure loss to generate the maximal swirl intensity. When applying to different processing systems, for example, in cleaning a milk processing device, a smaller ratio (such as 6:1) may be used to generate a better cleaning effect.

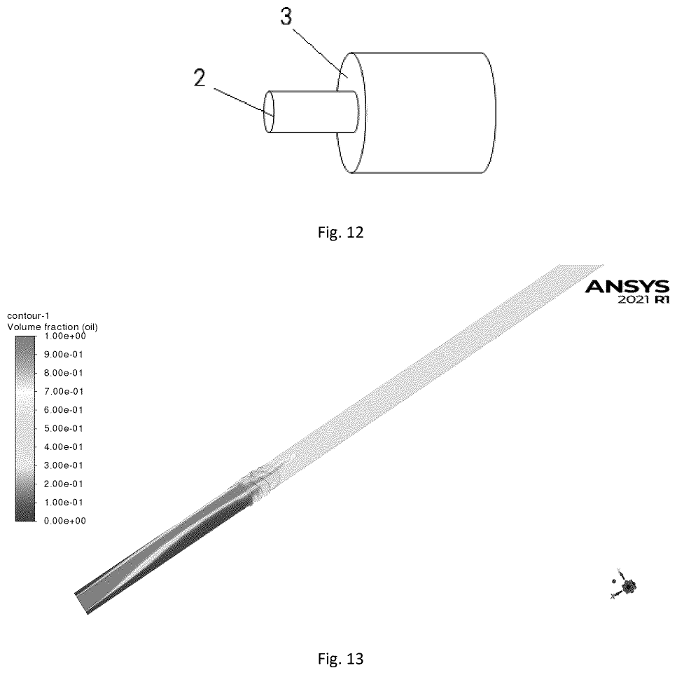

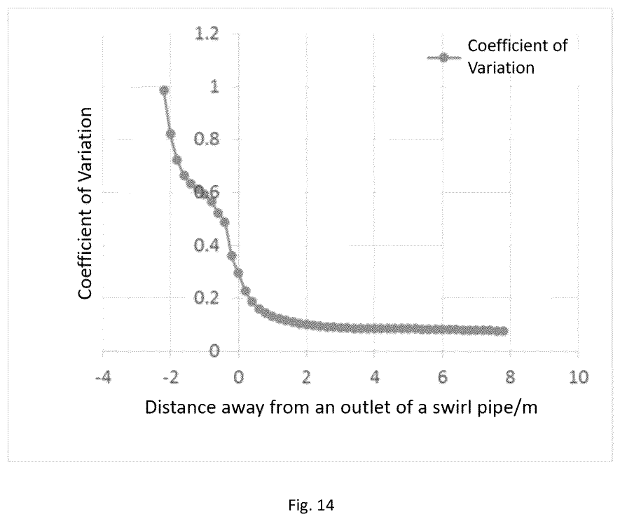

In addition to the above typical implementation, a relatively simple liquid raw material feeding mode is shown in FIG. 12. It can be directly connected to the second swirl pipe 5 or the first mixing action continuing region in the typical implementation in FIG. 1. This implementation is relatively simple, and is suitable for mixing applications with relatively low mixing uniformity requirements such as the coefficient of variation of about 0.05. The first liquid raw material enters from a small circular pipe, and the second liquid raw material enters from an annular inlet. A simulated diagram is shown in FIG. 13, and the distribution of the coefficient of variation is shown in FIG. 14.

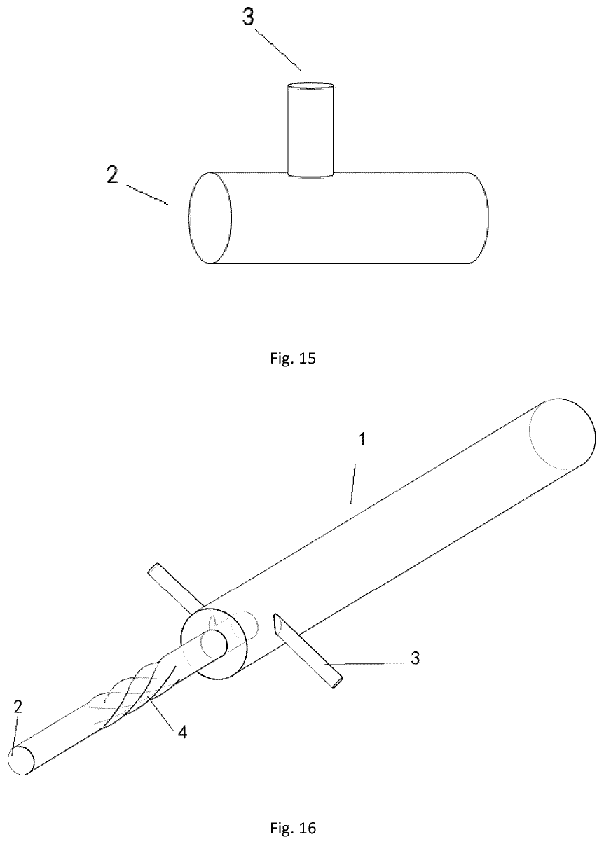

Another simpler implementation is shown in FIG. 15. The first liquid raw material enters from a horizontal circular pipe, and the second liquid raw material enters from a vertical circular pipe.

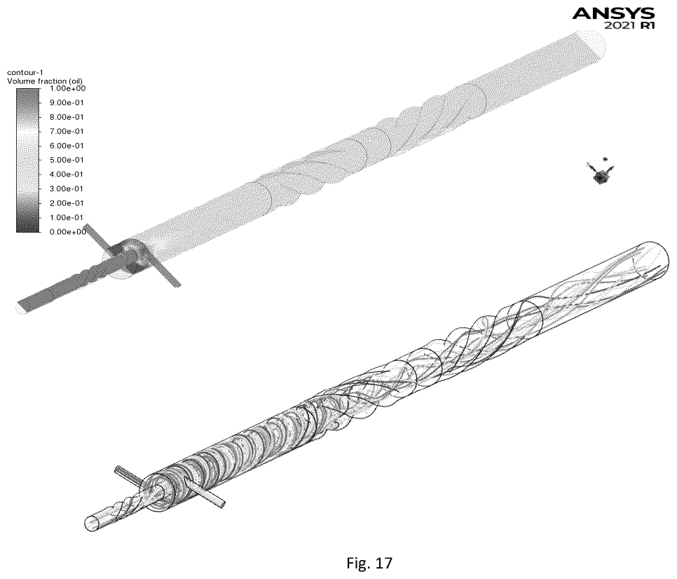

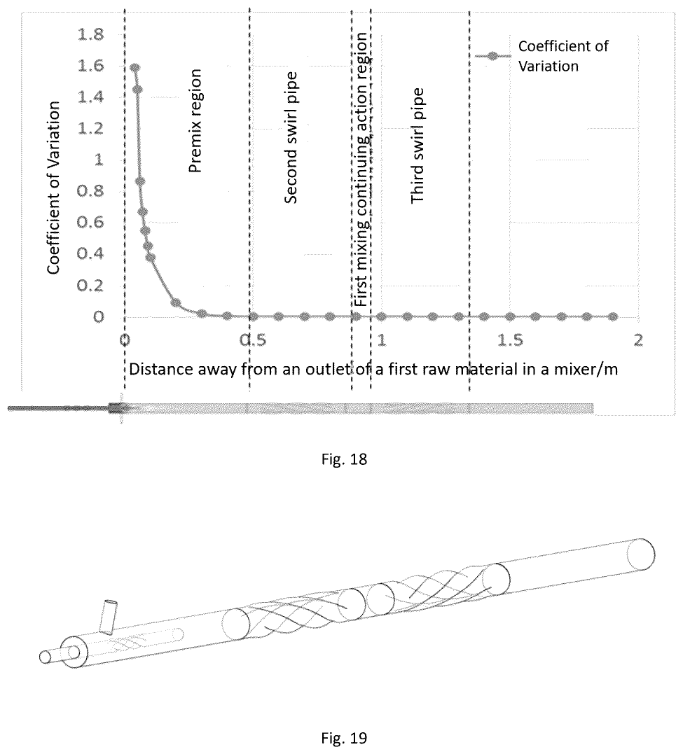

As shown in FIG. 16, according to another inlet implementation, the first swirl pipe 4 positioned inside the mixer may be moved outside, so that an outlet of the first kind of liquid raw material and two outlets of the second liquid raw material in the mixer are gathered in the same region, and are mutually mixed with shearing and splitting. This allows the two kinds of liquid to mix earlier. In this implementation, the swirl rotation direction generated in the first raw material inlet 2 is consistent with the swirl rotation direction formed at the second raw material tangential inlet of the next implementation, and is opposite to the rotation direction of the subsequent second swirl pipe 5. A CFD simulation shows that a mixing effect generated by this liquid raw material inlet implementation is better, since the length and effect of the premix region 7 are prolonged, and a better degree of mixing can be achieved in the premix region 7, indicated by a coefficient of variation close to 0.01. Complete mixing can be achieved after passing through the second swirl pipe 5. A simulated diagram of this implementation is shown in FIG. 17, and the corresponding variation of the coefficient of variation is shown in FIG. 18.

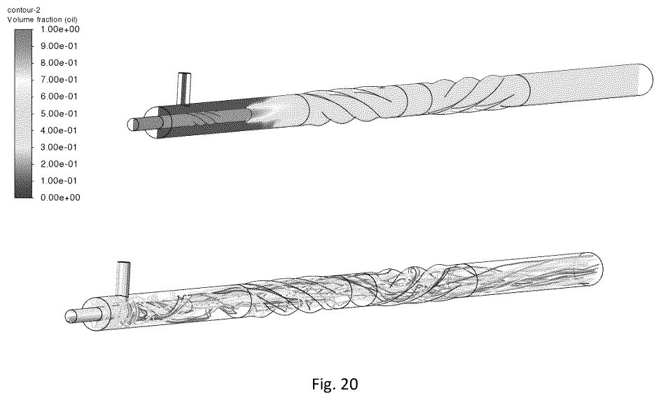

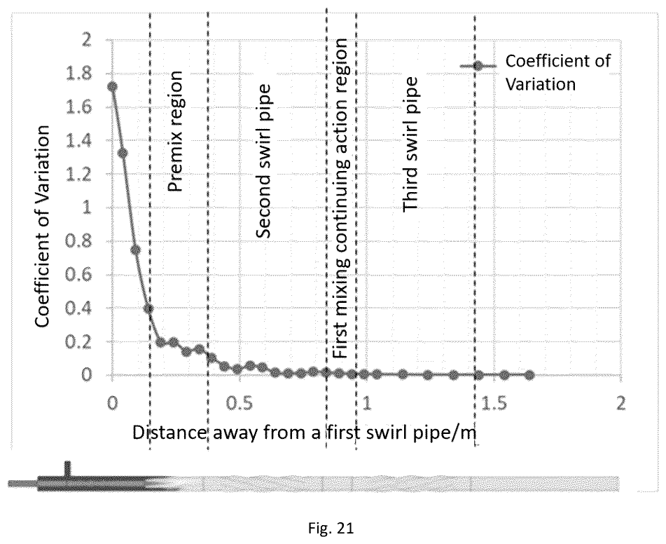

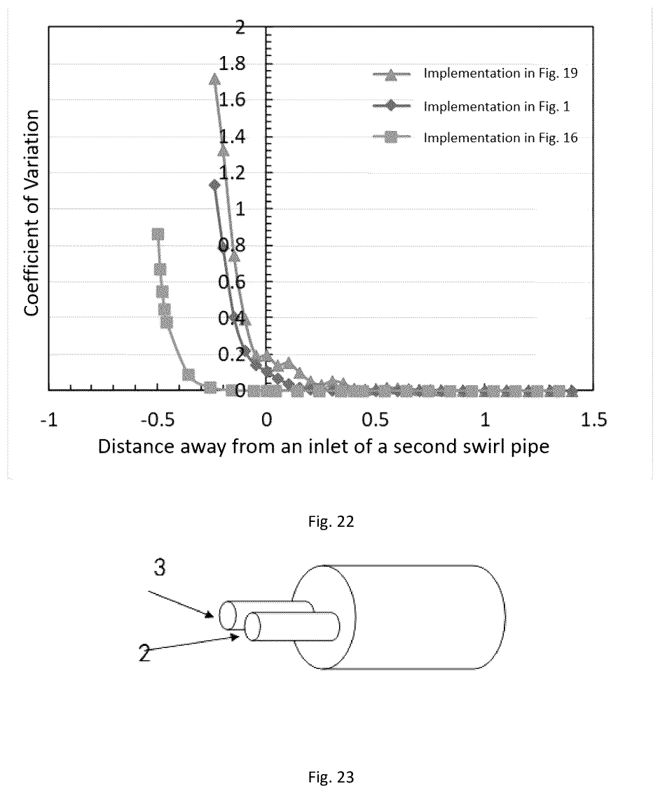

FIG. 19 is a schematic diagram of the raw material coefficient of variation of an embodiment of a swirl-type liquid raw material in-line static mixer of the present disclosure. FIG. 20 is the distribution diagram of the raw material volume fraction and the liquid raw material flow line trajectory chart of this embodiment of a swirl-type liquid raw material in-line static mixer of the present disclosure. FIG. 21 is a schematic diagram of the raw material coefficient of variation of this embodiment of a swirl-type liquid raw material in-line static mixer of the present disclosure. FIG. 22 is a comparison diagram of the raw material coefficient of variation of the three implementations of FIG. 19, FIG. 1 and FIG. 16. It can be indicated from the diagrams that the implementation of the raw material inlet has an important effect on the final liquid raw material mixing effect. Compared to the implementation of FIG. 19, the implementation of FIG. 1 applies a tangential inlet to the second kind of liquid raw material, and this increases the swirl intensity and mixing effect of a premix section. According to the implementation shown in FIG. 16, the two kinds of liquid act with each other directly when entering the system, impacting each other for mixing, therefore the mixing effect of the premix region is further improved, and the final mixing effect is also better. These comparisons show that a creative design on how to feed the liquid raw materials to the system has an important action on the effect of the static mixer.

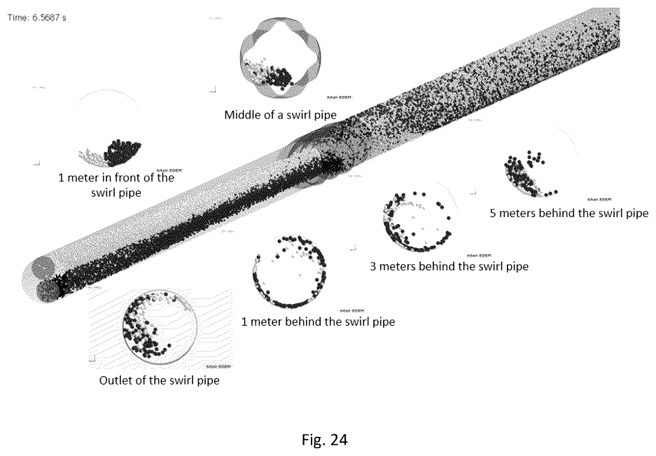

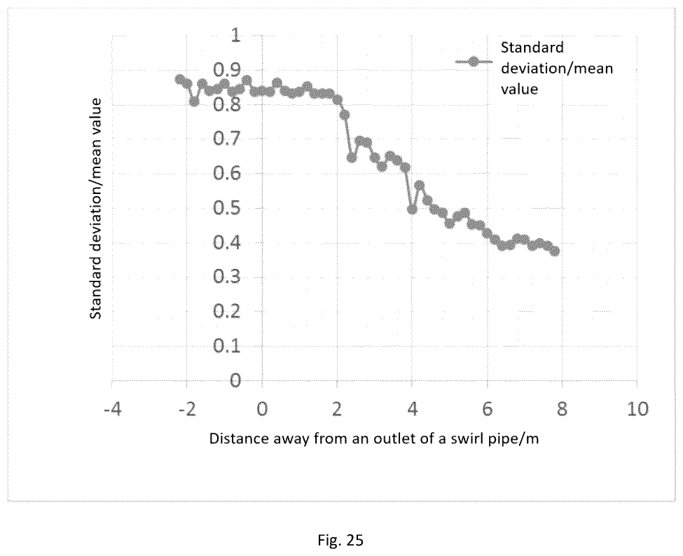

The above implementations of the present disclosure are suitable for mixing liquid raw material containing particles as well. When the particles have small diameters, such as a micro order, and a density close to the raw material liquid, the above several kinds of raw material inlet implementations all can reach a good mixing effect. When the particles are larger, a liquid raw material feeding type containing particles shown in FIG. 23 may be adopted. The inlet of the first kind of the raw material containing particles and the inlet of the second kind of the raw material containing particles may be arranged in parallel. As shown in FIG. 24 to FIG. 25, the two different kinds of particles enter the pipeline in parallel are not mixed before entering the swirl pipe, and are clearly mixed after entering the swirl pipe. A coefficient of variation analysis method similar to that when different liquids are mixed is adopted. Along the above simulated pipeline, a number of different cross sections are created and each cross section is divided into 100 cells. The number of the first kind of particles in each of the 100 cells are obtained (100 data are obtained), and a standard deviation and a mean value of the 100 data are calculated based on the data obtained. A distribution diagram of the coefficient of variation of the particles in the flow direction of the pipeline is obtained and plotted in FIG. 25. It can be seen that, after passing through the swirl pipe, the mixing degree of the particles has clearly increased. The monitored number of collisions between the two kinds of particles is increased downstream of the swirl pipe, indicating the enhancement of mixing.

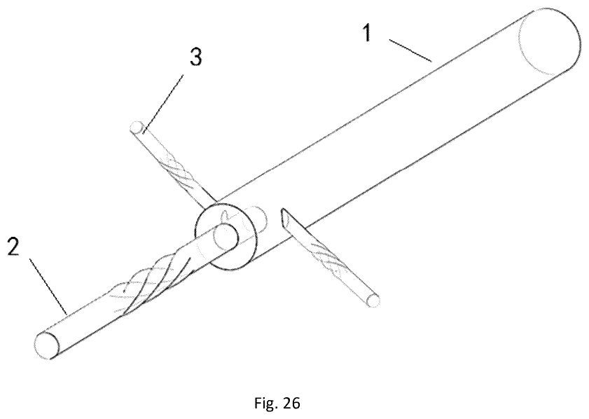

FIG. 26 is a schematic diagram of an arrangement of a second raw material inlet of an embodiment of a swirl-type liquid raw material in-line static mixer of the present disclosure. This implementation is suitable for liquid raw materials with a larger mixing difficulty. swirl pipes are additionally arranged at inlets of two sides of the second kind of liquid raw material, so that the liquid raw material enters the mixer with a swirl shear effect, to promote stronger mixing of liquids. The basic principles of the present application are described above in conjunction with the specific embodiments; however, it needs to be indicated that the advantages, strengths and effects mentioned in the present application are only examples and are not limitations and should not be considered as a prerequisite for various embodiments of the present application. Besides, the above disclosed specific details are merely used for illustration and better understanding instead of a limitation. The above details do not limit the present application being implemented necessarily by using the above specific details.

The above description has been given for the purpose of illustration and description. In addition, the description is not intended to limit the embodiments of the present application in the present disclosure. Although various example aspects and embodiments have been discussed above, a person of ordinary skill in the art will recognize some variations, modifications, changes, additions and sub-combinations.

1. A swirl-type liquid raw material in-line static mixer, comprising:
a pipe body, extending along its central axis;
a first raw material inlet, arranged at the top end of the pipe body and collinear with the central axis;
a second raw material inlet, arranged on a side wall of the pipe body and perpendicular to the central axis;
a first swirl pipe, arranged in the pipe body and connecting with the first raw material inlet;
a second swirl pipe, arranged in the pipe body and connecting with the first swirl pipe and the second raw material inlet;
a third swirl pipe, arranged in the pipe body and connecting with the second swirl pipe; and
an outlet, arranged at the bottom end of the pipe body and connecting with the third swirl pipe, wherein the first swirl pipe, the second swirl pipe and the third swirl pipe each comprise an inner pipe wall located in the pipe body, and each inner pipe wall comprises:
a first transition section, located at the upper end of the inner pipe wall and having a first length and a first cross section in a longitudinal direction of a swirl pipe, wherein the first cross section gradually changes smoothly from a circle with a radius of R to a lobed shape while being twisted by a first predetermined angle longitudinally along with the first transition section, the lobed shape comprises a square with a side length of 2r and a semicircle having a radius of r and extending on each side of the square, with the cross-sectional area of the said first cross section remains unchanged;
a swirl section, connected to the first transition section and having a second length and a second cross section in the longitudinal direction of the swirl pipe, wherein the second cross section is twisted by a second predetermined angle longitudinally along with the swirl section, and the second cross section is in a lobed shape; and
a second transition section, connected to the swirl section, located at a lower end of the inner pipe wall and having a third length and a third cross section in the longitudinal direction of the swirl pipe, wherein the third cross section gradually changes smoothly from a lobed shape to a circle with a radius of R while being twisted by a third predetermined angle longitudinally along with the second transition section, and a cross-sectional area of the third cross section remains unchanged.

2. The swirl-type liquid raw material in-line static mixer according to claim 1, wherein, preferably, the second raw material inlet comprises two inlet pipes arranged on opposite sides of the pipe body and not on the same horizontal plane.

3. The swirl-type liquid raw material in-line static mixer according to claim 1, wherein the rotation direction of the first swirl pipe is opposite to that of the second swirl pipe, and the rotation direction of the third swirl pipe is opposite to that of the second swirl pipe.

4. The swirl-type liquid raw material in-line static mixer according to claim 1, wherein a pipe body between the first swirl pipe and the second swirl pipe is a premix region, with a length being 1 to 120 times the diameter of the first swirl pipe.

5. The swirl-type liquid raw material in-line static mixer according to claim 1, wherein a pipe body between the third swirl pipe and the second swirl pipe is a straight pipe, with a length being 1 to 120 times the diameter of the second swirl pipe.

6. The swirl-type liquid raw material in-line static mixer according to claim 1, wherein at least one swirl pipe with opposite rotation directions is sequentially arranged between the outlet and the third swirl pipe.

7. The swirl-type liquid raw material in-line static mixer according to claim 1, wherein the lobed shape is a 2-lobed shape, a 3-lobed shape, a 4-lobed shape, a 5-lobed shape or a 6-lobed shape.

8. The swirl-type liquid raw material in-line static mixer according to claim 1, wherein the first predetermined angle is 90 degrees, the second predetermined angle is 180 degrees, and the third predetermined angle is 80 degrees.

9. The swirl-type liquid raw material in-line static mixer according to claim 1, wherein a twisting angle of the first cross section and/or a twisting angle of the third cross section gradually change/changes based on an a transition curve, wherein
$$α = {[ \frac{1 - cos [ {π ( \frac{x}{L} )}^{t} ]}{2} ]}^{k} ,$$
L is the first length, x is a position coordinate of the first cross section in a length direction, and t and k are two power-law variation coefficients for the α transition curve.

10. The swirl-type liquid raw material in-line static mixer according to claim 1, wherein the twisting angle of the first cross section and/or a twisting angle of the third cross section gradually change/changes based on a Vitoshinsky curve or a cosine function.
